(19) United States
(12) Patent Application Publication
(10) Pub. No.: US 2008/0258933 A1
(43) Pub. Date: Oct. 23, 2008

(54) Emergency traffic light system

(76) Inventor: Keyvan Diba, Los Angeles, CA (US)

Correspondence Address: LAUSON & SCHEWE LLP, 880 APOLLO STREET, SUITE 301, EL SEGUNDO, CA, 90245, US

(21) Appl. No.: 11/787,917

(22) Filed: Apr. 19, 2007

(51) Int. Cl. G08G 1/095

(52) U.S. Cl. 340/907

(57) ABSTRACT

A supplemental system of stop lights for use in conjunction with a primary stop light system. Solar powered supplemental stop light units are mechanically attached nearby the stop light units of the primary system. Should the primary system fail, the supplemental stop lights become active to re-establish control of the traffic flow and substitute for the disabled primary stop light system. The supplemental stop light system uses at least two visual displays: a graphics display and an alphanumeric verbal display. In an alternative use in conjunction with emergency vehicle traffic, an alphanumeric numeric display can be advantageously employed.

### BACKGROUND OF THE INVENTION

1. Field of the Invention

This invention relates to devices that enhance stop light operation for emergency traffic and for primary stop light failure and more particularly to a supplemental stop light indication system that responds to police, fire, and other emergency traffic or to a failure of the primary stop light system by indicating a “stop”, the approach of emergency traffic, or other relevant messages to all traffic at the stop light intersection.

2. Description of the Related Art

Stop lights, street lights, or traffic lights are known in the art for use at intersections where oncoming traffic meets. With the use of stop lights, traffic at an intersection can be directed in a safe and efficient manner to avoid collisions and to increase the flow of traffic.

Occasionally, the primary stop lights at an intersection will fail due to the failure of the power supply or due to mechanical damage to the stop lights (e.g., an auto crashes into the control box or one of the stop light poles). In such an event, the operation of the primary stop lights will cease or be severely impaired. Under such circumstances, it would be advantageous to have an auxiliary stop light system that can supplement the primary stop light system by continuing to direct traffic through the intersection. Such an auxiliary stop light system would contribute more to the control of traffic if it could coordinate the traffic flow when the primary stop light system had failed. Furthermore, such an auxiliary stop light system should stand alone and apart from the primary stop light system by relying upon its own and self-contained source of power. As the power supply for the supplemental stop light system would be separate from the power supply for the primary stop light system, failure of the primary stop light system would have less of a chance of impairing the supplemental stop light system. It would also increase the utility of the supplemental stop light system if it responded to emergency traffic in order to temporarily seize control of the local traffic flow.

Frequently, emergency traffic such as police cars, fire trucks, and ambulances must pass through busy intersections in order to make their way to their destinations such as crime scenes, fires, and medical emergencies, respectively. In so doing, such emergency vehicles flash bright lights and emit sirens in order to alert traffic of their passage. When so alerted, such traffic pulls over to the curb in order to allow the quick and safe passage of the emergency vehicle.

Certain difficulties arise with the passage of emergency vehicles through intersections. The acoustic environment surrounding the intersection may be such that the direction of an approaching siren may be quite difficult to place. When a driver in traffic is unable to place the direction of the siren, that driver is unable to anticipate the direction of the emergency vehicle. Moreover, the driver may be unable to hear the siren at all. If the emergency vehicle is obscured by a building or other visual obstacle, the driver may in no way be aware of approaching emergency traffic at an intersection.

This can be a dangerous situation as emergency traffic is allowed to pass “against the red” at a stop light. If a driver is not alerted to the approach of emergency traffic, that driver may pass into the intersection with the green light of the stop light, while, simultaneously, the emergency vehicle(s) enter into the intersection against the red. Although collisions between the vehicles incoming to the intersection may be avoided through quick response, the progress of the emergency vehicles will be slowed and their response to an emergency situation will be delayed.

### SUMMARY OF THE INVENTION

The present invention resides in an auxiliary/supplementary stop light system that supports and augments the primary stop light system at an intersection.

Supplemental stop lights having three visual displays are attached alongside the stop lights of the primary stop light system. A visual graphics display has series of red and green light emitting diodes (LEDs) to provide illumination for the graphics display and to transmit the appropriate color code signal (green for “go”, red for “stop”) to the approaching traffic. A smaller alphanumeric display mainly for the transmission of verbal information is attached to the graphics display. The verbal display is also illuminated by LEDs. The verbal display displays a message that corresponds to the signal transmitted by the graphics display such as “green” or “red” according to the color of the graphics display. An additional alphanumeric display mainly for the transmission of numeric information may be optionally connected to the graphics and verbal displays. The numeric display is electronic in nature and is illuminated by LEDs

A solar cell connected to the supplemental stop light supplies power to rechargeable batteries. When called into use, the supplemental stop light draws its power from the rechargeable batteries. A connection between the primary and supplementary stop light systems provides means by which the supplemental stop lights can determine if the primary system is operating or disabled. A handheld transmitter allows manual control of the supplemental stop lights so that more efficient traffic control can be directed by police or other civic employees.

When used in conjunction with emergency traffic, the supplemental stop lights can implement and display a series of signals indicating the approach of emergency traffic and that guide the traffic accordingly. For traffic perpendicular to the current approach of emergency traffic, a stop signal is displayed resembling a red target by the graphics display. The word “stop” is displayed by the verbal display and the numeric display displays the distance of the emergency traffic from the intersection. For traffic parallel to the current approach of emergency traffic, a right-pointing directional arrow display is transmitted by the graphics display to urge the parallel traffic to pull over to the right and allow the emergency traffic to more easily pass by. The word “stop” is alternatingly the word “right” by the verbal display and the numeric display again displays the distance of the emergency traffic from the intersection. A transmitter associated with the emergency vehicle(s) enables the emergency traffic to control the operation of the supplemental stop light system.

### OBJECTS OF THE INVENTION

It is an object of the present invention to provide a system of stop lights that supplement a primary stop light system.

It is an object of the present invention to provide a supplemental stop light system that provides traffic control when the associated primary stop light system fails.

It is an object of the present invention to provide a supplemental stop light system that provides additional traffic control allowing the safer and more rapid travel of emergency traffic.

These and other objects and advantages of the present invention will be apparent from a review of the following specification and accompanying drawings.

### BRIEF DESCRIPTION OF THE DRAWINGS

FIG. 1 is a front perspective view of a supplemental stop light of the present system showing the graphics and verbal displays with the numeric display detached.

FIG. 2 is a rear perspective view of the supplemental stop light of FIG. 1 with the solar panel raised to a higher degree with a broken away portion showing the electronic controller and rechargeable batteries.

FIG. 3 is a front perspective view of a supplemental stop light of the present system showing the numeric display attached to the graphics and verbal displays which are indicating a “pull over” signal.

FIG. 4 is a front perspective view of a supplemental stop light of the present system without the numeric display, a handheld transmitter controlling the operation of the stop light.

### DESCRIPTION OF THE PREFERRED EMBODIMENT(S)

The supplemental stop light system of the present invention uses a series of self-powered stop lights that accompany the stop lights of the primary stop light system. The supplemental stop lights may be attached as convenient to the structures supporting the primary stop lights, providing means by which the supplemental stop light system of the present invention may be added to existing stop lights.

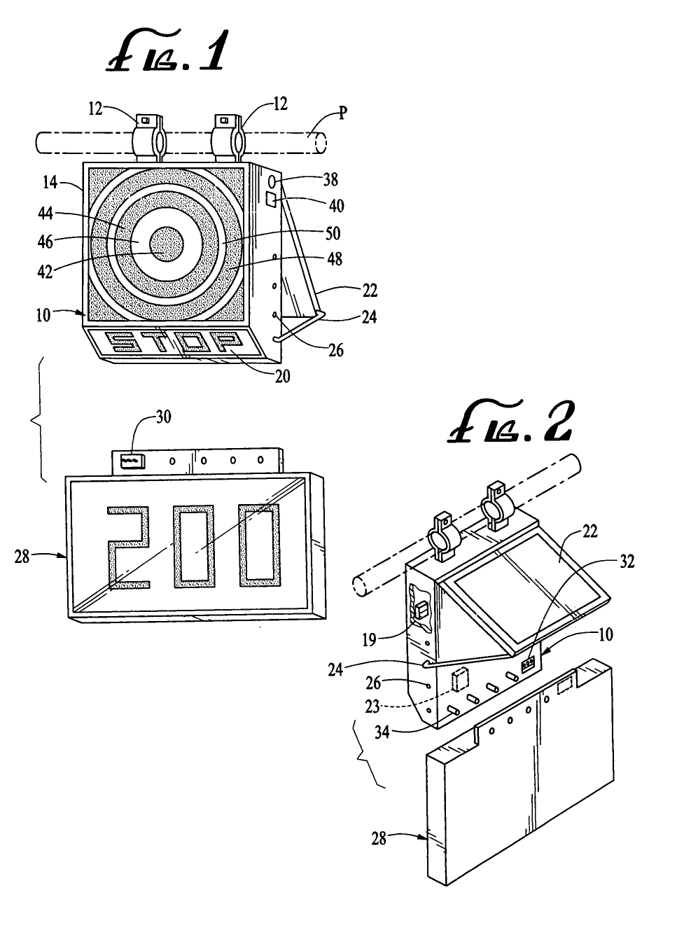

As shown in FIG. 1, a housing 10 is attached as by clamps 12 to a pipe P or other structure associated with a-primary stop light system. As used herein, the term primary stop light system refers to the commonplace and everyday stop lights often seen at intersections in cities and towns. It is as an auxiliary stop light system supplementing the primary stop light system that the present invention is seen as finding its best utility.

The housing 10 provides protection and support for several structures internal to the housing. A visual graphics display 14 directly faces the oncoming traffic. Preferably, series of red 16 and green 18 light emitting diodes (LEDs, see FIG. 4) are present in and provide illumination for the graphics display 14. Other forms of illumination, such as fiber optics, may also be used to illuminate the graphics display 14 and other displays of the present invention. Electronic circuitry in the form of a controller 19 internal to the housing 10 provides the appropriate signals that control the operation of the LEDs 16, 18 of the graphics display 14.

Below the graphics display 14 and held in place by the housing 10 is an alphanumeric verbal display 20 that is also illuminated by LEDs. The controller 19 provides the signals necessary to control the verbal display 20, especially in the display of letters and words to transmit messages to oncoming traffic.

To the rear of FIG. 1 and as seen in FIG. 2, a solar panel 22 is present that is pivotably attached to the top of the housing 10. The solar panel 22 supplies a set of rechargeable batteries 23 within the housing 10 with electric power when the sun or other appropriate light shines upon the solar panel 22. A bracket arm 24 controls the angle at which the solar panel 22 is held with respect to the housing 10. The bracket arm 24 is pivotably connected to a far corner of the solar panel 22 and may be lodged in a series of holes 26 present in the side of the housing 10. The bracket arm holes 26 allow the angle of the solar panel 22 to be adjusted with lower holes decreasing the angle and higher holes increasing the angle.

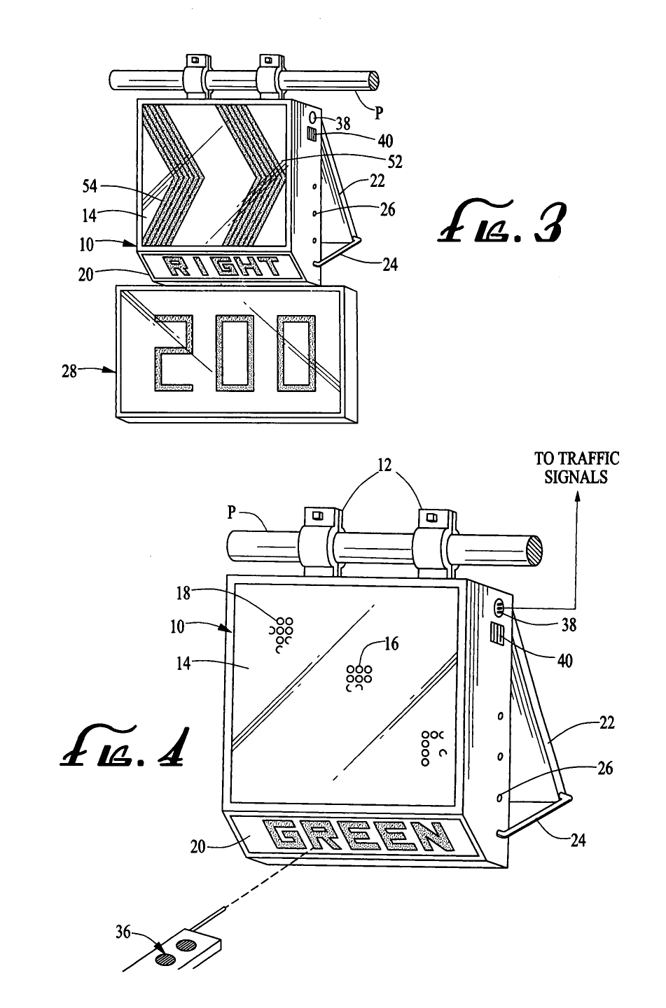

As seen in FIGS. 1, 2, and 3, a detachably attachable alphanumeric visual display 28 can be used to provide further information, especially numeric information, to the oncoming traffic. Series of LEDs are used to provide illumination for the numeric display 28. A plug 30 on the numeric display 28 mates with a socket 32 on the rear of the housing 10 so that the numeric display 28 may be coupled to and controlled by the controller 19. Pins 34 or other means may be used to detachably attach the numeric display 28 to the housing 10. Such pins 34 could fit into holes or sockets 35 present in the rear of the housing 10.

As shown in FIG. 4, a handheld transmitter 36 may be used to control the operation of the graphics 14 and verbal 20 displays. A receiver coupled to the controller 19 receives signals from the transmitter 36. One set of signals from the transmitter 36 may indicate that a green “go” signal should be displayed by the graphics 14 and verbal 20 displays. Another set of signals from the transmitter 36 may indicate that a red “stop” signal should be displayed.

As seen in the FIGURES, the right side of the housing 10 has a number of apertures present, including those previously indicated as bracket arm holes,26. One of these apertures is for a socket 38. The socket aperture partially envelopes the socket 38 through which the supplemental stop light may be coupled to the primary stop light system. When coupled to the primary stop light system, the supplemental stop light system of the present invention can determine (via the controller 19) the operating status of the primary stop light system. If the primary stop light system should fail for some reason, the coupling to the supplemental stop light system allows the controller 19 to detect the failure and to initiate the operating sequence of the supplemental stop light system.

A horn 40 incorporated within the housing 10 provides aural or acoustic warning to nearby pedestrians. The horn 40 is coupled to the controller 19 and when the supplemental stop light system is activated, provides additional means by which traffic safety may be better achieved. Nearby pedestrians are warned both of the failure of the primary stop light system as well as the approach of oncoming traffic, according to the instructions of the controller 19.

In operation, the stop lights of the present invention are clamped or otherwise attached to a primary stop light support. While the primary stop lights function, or while there is no emergency traffic, the supplemental stop lights are dormant and store energy from the solar panels 22 in their rechargeable batteries 23. Only when activated by primary stop light failure and/or emergency traffic do the supplemental stop lights of the present invention operate.

When the primary stop light system fails due to a power failure, automobile accident, or otherwise, the supplemental stop lights of the present system detect the primary system failure through their couplings to the primary stop light system. Upon detecting the primary stop light system failure, the supplemental stop lights are activated to warn oncoming traffic of the primary stop light system failure.

In order to warn the oncoming traffic of the primary stop light failure, the supplemental stop lights initially stop all traffic at the intersection before they begin to direct traffic. A “stop” signal is displayed by both the graphics 14 and verbal 20 displays to indicate to all oncoming traffic that no entry should be made into the intersection. As currently contemplated, the “stop” signal of the graphics display 14 begins by illuminating a circle of red LEDs 42 at the center of the graphics display 14. After a short period of time, a first ring of red LEDs 44 is illuminated a short distance away from the illuminated LEDs at the center of the display 14, leaving a first ring of LEDs 46 that are not lit between the, center dot 42 and the first ring 46. After another short period of time, a second ring of red LEDs 48 is illuminated leaving a second ring of LEDs 50 that are not illuminated between the first LED ring 44 and the second LED ring 48.

This sequence is repeated until the graphics display 14 is filled with alternating rings of lit and unlit LEDs. Once the display 14 is filled, a short period of time is allowed to pass before the sequence is repeated. In this way, a visual display is generated by the graphics display 14 that resembles an approaching target. The movement of the graphics display 14 as it illuminates is noticeable by and attracts the attention of the drivers in the oncoming traffic. As the graphics display 14 is made more noticeable by the display sequence, traffic is better and more safely controlled. When fully illuminated with the “approaching target” display, the graphics display 14 appears as shown in FIG. 1.

Coordinated with the display of the “approaching target” by the graphics display 14, the verbal display 20 flashes the word “stop” with each illumination of an additional LED ring by the graphics display 14. As nine percent of the population suffers from some degree of red-green color blindness, the verbal message displayed by the verbal display 20 aids in preventing any misinterpretation of the supplemental stop light signal by color blind drivers.

Once traffic has been stopped by the supplemental stop lights and traffic control has been re-established by the supplemental stop light system, the re-establishment of safe and controlled traffic flow is commenced. In order to provide safe and controlled traffic flow, timers or clocks within the controllers 19 of the supplemental stop lights are engaged. For an intersection with four primary and supplemental stop lights, it can be considered for purposes of example that one pair of each stop light faces east/west while the other pairs face north/south.

After traffic flow has been stopped and traffic control re-established at the intersection, a certain period of time will have elapsed that can be assumed to be on the order of about two minutes. Once this initial period has elapsed, one pair of stoplights (for example, the east/west stoplights) will cease to display the “approaching target” display and will illuminate all the green LEDs present in the graphics display 14. In conjunction with the green LED display the verbal display 20 will display the word “green” as a verbal indicator that the traffic oncoming to the east/west supplemental stop lights should proceed through the intersection. This display is shown in FIG. 4.

Continuing this example, when the east/west stoplights begin to go green, the other pair of supplemental stop lights (for example, the north/south stop lights) will begin to go red, initially by ceasing to display the “approaching target” display. After the “approaching target” display is extinguished, the north/south supplemental stop lights illuminate all the red LEDs present in the graphics display 14. In conjunction with the red LED display, the verbal displays 20 of the north/south supplemental stop lights will display the word “red”.

The clocks within the controllers 19 measure the time elapsed since the present displays were initiated. After a short period of time on the order of about two minutes has elapsed, the controllers 19 change exchange their displays with the east/west supplemental stop lights going red and the north/south supplemental stop lights going green. For increased safety, the supplemental stop lights going from red to green may delay their transition with respect to the other pair of supplemental stop lights in order to allow traffic passing through the intersection to complete the journey before allowing cross traffic to enter the intersection.

Manual control over the operation of the supplemental stop lights may be established via a remote control, such as the handheld transmitter 36 shown in FIG. 4. Alternatively, a remote control may be established through wires linking the supplemental stop lights. The handheld transmitter 36 has two buttons to control the operation of the supplemental stop lights. One button places an opposing pair of supplemental stop lights in the green display mode while the other pair are in the red mode. The other button reverses the displays with the first supplemental stop lights showing red and the other pair showing green.. As with the automatic operation of the supplemental stop lights set forth above, there may be a delay in the red to green transition.

Emergency traffic may use the supplemental stop light system of the present invention to usurp, modify, amend, or otherwise alter the control of the primary stop light system. Transmitters (potentially similar to the handheld transmitter 36) are present in emergency vehicles and become active when the emergency vehicle responds to an emergency call. Receivers (not shown) are present within the housing 10 and are coupled to the controller 19. Signals transmitted by the transmitters are received by the receivers and are in turn detected by the controller 19. When the transmitter signals are detected by the controller 19, emergency traffic control signals are implemented by the supplemental stop lights according to the direction of travel of the emergency vehicle(s).

For the supplemental stop lights controlling traffic perpendicular to the direction of travel of an emergency vehicle, the pair of supplemental stop lights display the “approaching target” graphic display and the word stop as set forth above. This display to the flow of traffic perpendicular to the direction of travel of the emergency vehicle is designed to bring the perpendicular traffic flow to a halt, thereby allowing the emergency vehicle to pass.

For the supplemental stop lights controlling traffic parallel to the emergency vehicle's direction, a different display is delivered. Instead of the “approaching target” display of the perpendicular flow supplemental stop lights, the parallel flow supplemental stop lights present a display that urges the traffic to stop and pull over to the right. The graphics display 14 displays a travelling right direction arrow of red 52 and green 54 LEDs. As the travelling right direction arrow moves across the graphics display 14 to the right, the verbal display 20 presents an alternating message of “right” in green LEDs with “stop” in red LEDs. In this way, traffic travelling parallel to the direction of travel of the emergency vehicle are informed of the emergency vehicle's approach and can take the appropriate action in response thereto.

To further add greater utility to the supplemental stop light system of the present invention when used to aid the travel of emergency vehicle's, the numeric display 28 can be used to indicate the distance the emergency vehicle is from the intersection. When the receiver in the housing 10 receives the transmitter's signal, the controller 19 may determine from that signal the distance the emergency vehicle is from the supplemental stop light. When the controller 19 so determines this distance, it can display this information to oncoming traffic by controlling the numeric display 28 to display a number representing the distance the emergency vehicle is from the intersection. As the emergency vehicle approaches the intersection, the number displayed by the numeric display 28 will change, reflecting the emergency vehicle's approach. Drivers in traffic seeing the number in the numeric display 28 are then made aware of the incipient approach of the emergency vehicle and can gauge the time in which they will have to act in order to allow the emergency vehicle to pass safely by.

Communication between the individual supplemental stop light units may be achieved by wires or electromagnetic transception. Alternatively, the individual units may each stand alone, any signals received being deciphered and interpreted by their controllers 19.

While the present invention has been described with regards to particular embodiments, it is recognized that additional variations of the present invention may be devised without departing from the inventive concept.

What is claimed is:

1. A supplemental stop light unit, comprising:
a housing, said housing adapted to be mounted adjacent to a primary stop light unit;
a graphics display held in place by said housing, said graphics display comprising illumination sources for producing instructional information in a graphical form to control and direct traffic flow;
a verbal display held in place by said housing, said verbal display comprising illumination sources for producing instructional information in a verbal form to control and direct traffic flow;
a controller, said controller coupled in input relationship to said graphics display and said verbal display, said controller for producing and transmitting coordinated signals to said graphics display and said verbal display in order to control and direct traffic flow.

2. The supplemental stop light unit of claim 1, further comprising:
a rechargeable battery, said rechargeable battery coupled to and supplying power for said controller; and
a solar panel coupled to said rechargeable battery, said solar panel converting incident light to electrical energy to recharge said rechargeable battery.

3. The supplemental stop light unit of claim 1, wherein said illumination sources for said graphics display and said verbal display comprise red and green LEDs.

4. The supplemental stop light unit of claim 1, further comprising:
a numeric display, said numeric display coupled to and coordinated by said controller,, said numeric display comprising illumination sources for producing instructional information in a numeric form to control and direct traffic.

5. The supplemental stop light unit of claim 1, further comprising a horn coupled to said controller, said horn warning pedestrians of traffic conditions.

6. The supplemental stop light unit of claim 1, further comprising:
a remote control coupled to said controller, said remote control allowing a person to operate the supplemental stop light unit.

7. The supplemental stop light unit of claim 6, wherein said remote control is a handheld transmitter electromagnetically coupled to said transmitter.

8. The supplemental stop light unit of claim 1, wherein said controller is coupled to a primary stop light system.

9. A supplemental stop light unit, comprising:
a housing, said housing adapted to be mounted adjacent to a primary stop light unit;
a graphics display held in place by said housing, said graphics display comprising red and green LED illumination sources for producing instructional information in a graphical form to control and direct traffic flow;
a verbal display held in place by said housing, said verbal display comprising red and green LED illumination sources for producing instructional information in a verbal form to control and direct traffic flow;
a controller, said controller coupled in input relationship to said graphics display and said verbal display, said controller for producing and transmitting coordinated signals to said graphics display and said verbal display in order to control and direct traffic flow;
a rechargeable battery, said rechargeable battery coupled to and supplying power for said supplemental stop light unit;
a solar panel coupled to said rechargeable battery, said solar panel converting incident light to electrical energy to recharge said rechargeable battery; and
a numeric display, said numeric display coupled to and coordinated by said controller, said numeric display comprising red and green LED illumination sources for producing instructional information in a numeric form to control and direct traffic.

10. A supplemental stop light system for a primary stop light system, comprising:
at least one supplemental stop light unit, said supplemental stop light unit having a graphics display for displaying graphical information to direct and control traffic and a verbal display for displaying verbal information to direct and control traffic, said graphics display and said verbal display coupled to and coordinated by a controller that produces and transmits coordinated signals to said graphics display and said verbal display, said supplemental stop light unit mechanically attaching adjacent to a primary stop light unit, said supplemental stop light unit being solar powered, there being one supplemental stop light unit for each primary stop light unit.
